(19) United States
(12) Patent Application Publication
(10) Pub. No.: US 2010/0289302 A1
(43) Pub. Date: Nov. 18, 2010

(54) Seat adjusting method and system thereof

(75) Inventor: Chien-Chuan Cheng, Taipei City (TW)

Correspondence Address: BACON & THOMAS, PLLC, 625 SLATERS LANE, FOURTH FLOOR, ALEXANDRIA, VA, 22314-1176, US

(73) Assignee: Nitring Enterprise Inc., Taipei City (TW)

(21) Appl. No.: 12/453,522

(22) Filed: May 14, 2009

(51) Int. Cl. A47C 7/46; A47C 3/00; G05D 7/06; A47C 7/74; A47C 7/62

(52) U.S. Cl. 297/180.12; 297/284.1; 700/282; 297/180.14; 297/217.1

(57) ABSTRACT

The present invention discloses a seat adjusting method and a seat adjusting system capable of actively adjusting a user's sitting posture and comfort according to the body weight of different users. Stress sensors are provided for detecting a stress distribution situation of a seat support surface. Airbags are buried into the support surface for actively changing the level of the support surface in order to increase a contact area between the support surface and the user, and the stress distribution situation can be matched with an expected ratio to provide the best ergonomic support effect to users.

### BACKGROUND OF THE INVENTION

1. Field of the Invention

The present invention relates to a seat support adjusting technology, in particular to a technology of actively adjusting a user's sitting posture and comfort by means of a stress distribution detection.

2. Description of the Related Art

In general, a seat support surface in contact with a user includes portions such as a cushion top and a front backrest, whose curvature and level can be adjusted according to a user's personal preference. In a conventional seat, a plurality of airbags are buried in the seat support surface, and an inflation/deflation control device is provided for the user to operate and adjust an inflated/deflected state of each airbag. If the user adjusts the inflated and deflated state of each airbag by the inflation/deflation control device, the curvature and level of the support surface will be changed, so that the way of the support surface in contact with the user will be changed accordingly, and the user can adjust a support effect of the support surface (such as adjusting the way of the cushion top being in contact with the user's thigh or the backrest being in contact with the user's back or lower back) according to the user's personal feeling.

Alternately, the inflation/deflation control device can be used for driving the airbags to have a dynamic change of inflation or deflation, so that the support surface can provide a dynamic support effect such as a massage to users.

Since different users may have different sitting habits and postures and subjective sensations, and the support effect adjusted by such method is not necessarily the best support effect as to human health care or medical science. For example, a user may adjust a seat support surface according to the user's subjective most comfortable mode within a few minutes before sitting on a seat, but such subjective most comfortable mode always involves an uneven distribution of stress, or even a support mode of a stress concentrated at a specific position, and thus causing a poor blood circulation or using excessive forces in some muscles. Once the user has sat for a long time, the user will feel uncomfortable, ached, or unease.

If such uncomfortable feeling occurs, the users usually adjust the support mode of the support surface according to their sensation. Since the uncomfortable feeling has occurred, the users generally adjust the support mode of the support surface excessively in order to eliminate the uncomfortable feeling immediately, so that the uncomfortable feeling will occur at other positions after the users have been sitting for some time.

In present existing technologies, some conventional seats come with a plurality of stress detectors corresponding to the airbags respectively, and a memory device for recording the stress situation of each airbag in order to find out and record the best support mode for a particular user, so that the same user can have the same support effect quickly for the next time.

However, the support effect obtained from the users' subjective sensation and experience usually does not fit a long sitting time for human bodies or even may cause chronicle harmful effects such as poor blood circulation or other health issues caused by the poor sitting posture to those sitting with an inappropriate posture for a long time.

In view of the shortcomings of the prior art, the inventor of the present invention developed a seat adjusting method and a seat adjusting system by adopting an active adjusting technology totally different from the traditional passive adjusting technology to provide a more comfortable sitting effect for users.

### SUMMARY OF THE INVENTION

Therefore, it is a primary objective of the present invention to provide a seat adjusting method and a seating adjusting system for actively adjusting a user's sitting posture and comfort.

The seat adjusting method of the present invention comprises the steps of: burying a plurality of airbags into an internal side of a support surface, wherein an inflated or deflated state of each airbag is controlled by an inflation/deflation control device; detecting a stress distribution situation of a seat support surface by a plurality of stress sensors; outputting a detected stress of each stress sensor to a control unit to produce a corresponding stress parameter, wherein the control unit is connected to a built-in memory for preloading an optimal stress parameter ratio; using the control unit to compare an actual stress parameter ratio obtained by the stress sensor with an optimal stress parameter ratio, when a user sits on a seat; and performing an adjusting procedure for inflating or deflating each airbag by the inflation/deflation control device according to a comparison result, wherein the comparison procedure and the adjusting procedure are carried out in cycles and stopped until the actual stress parameter ratio is matched with the optimal stress parameter ratio.

In the aforementioned process of adjusting the inflation and deflation of each airbag, the plurality of airbags buried into the support surface can change the level of the support surface, such that a contact area between the support surface and the user is increased, and the stress distribution situation can match an expected ratio to provide the most ergonomic support effect.

In practices, the inflation/deflation control device adjusts the airbags until the actual stress parameter ratio is matched with an optimal stress parameter ratio, and then the corresponding stress parameter of each stress sensor is recorded in the built-in memory. If the same user sits in the seat again, the control unit will not perform the comparison procedure again, but will drive the inflation/deflation control device directly to perform the adjusting procedure and will stop the adjusting procedure when the inflated/deflated mode of each airbag is matched with the recorded stress parameter.

Alternately, the control unit is connected to a portable storage device, such that the corresponding stress parameter of each stress sensor can be recorded into the portable storage device which provides the users a convenient carrying way, after the actual stress parameter ratio is matched with the optimal stress parameter ratio.

In summation of the foregoing method, the seat adjusting system of the present invention comprises a plurality of airbags buried in an internal side of the seat support surface, a plurality of stress detectors for detecting a stress distribution situation of a seat support surface to release a stress parameter, and an inflation/deflation control device connected to each stress detector for actively controlling an inflation or a deflation of each airbag according to the stress parameter.

The inflation/deflation control device further comprises a control unit connected to each stress detector for obtaining a stress parameter, a pump connected to the control unit, an air valve assembly connected to the control unit, an operating interface connected to the control unit, a built-in memory connected to the control unit for preloading an optimal stress parameter ratio, a portable storage device connected to the control unit; and a power supply device for supplying electric power required by the operation of the seat adjusting system.

In practices, a ventilation pipeline of this system is built between each airbag and the air valve assembly of the inflation/deflation control device, and the stress sensor is installed between each airbag and the support surface or installed on the ventilation pipeline. The inflation/deflation control device includes an electric port or a wireless transmission interface connected to the control unit and provided for the portable storage device to transmit data.

In addition to the adjusting effect, the aforementioned inflation/deflation control device can also provide a support effect to maintain the inflated/deflated mode of each airbag and perform a continuous or intermittent dynamic inflation/deflation control to specific airbags to provide users a touch feeling, so as to achieve a massaging effect.

The seat adjusting system of the present invention further comprises an auxiliary medical detector, and the auxiliary medical detector includes a cushion laid on the seat, a plurality of precision stress detectors distributed densely on the cushion, and a display device connected to the auxiliary medical detector for displaying the stress distribution situation, wherein the display of the stress distribution situation can be a data display or a graphic display provided for medical professionals to make decisions and adjust the mode of each stress distribution situation by the medical professionals, and thus the seat adjusting system of the present invention can be applied in auxiliary medical applications.

In addition, the seat adjusting system of the present invention further comprises an electrothermal component installed on an internal side of the support surface to provide a warmth retention effect to the seat adjusting system, a plurality of ventilation holes disposed on the support surface, and an air passage disposed in the seat for circulating an air flow and connected to an air blower, such that when the air blower produces an air flow, an active ventilation effect of the seat adjusting system can be achieved through the air passage and ventilation holes on the support surface.

Compared with the prior art, the present invention actively changes the mode of the support surface according to a stress detection result, so that the users can obtain a larger contact area and a support effect without an excessively concentrated stress.

### BRIEF DESCRIPTION OF THE DRAWINGS

FIG. 1 is a schematic view of an installation position of a seat adjusting system in accordance with a first preferred embodiment of the present invention;

FIG. 2 is a schematic view of an assembly of a seat adjusting system in accordance with a first preferred embodiment of the present invention;

FIG. 3 is a schematic view of an assembly of a seat adjusting system in accordance with a second preferred embodiment of the present invention;

FIG. 4 is a perspective view of a seat adjusting system in accordance with a third preferred embodiment of the present invention; and

FIG. 5 is a schematic side view of a seat adjusting system in accordance with a fourth preferred embodiment of the present invention.

### DETAILED DESCRIPTION OF THE PREFERRED EMBODIMENTS

The present invention will now be described in more detail hereinafter with reference to the accompanying drawings that show various embodiments of the invention as follows.

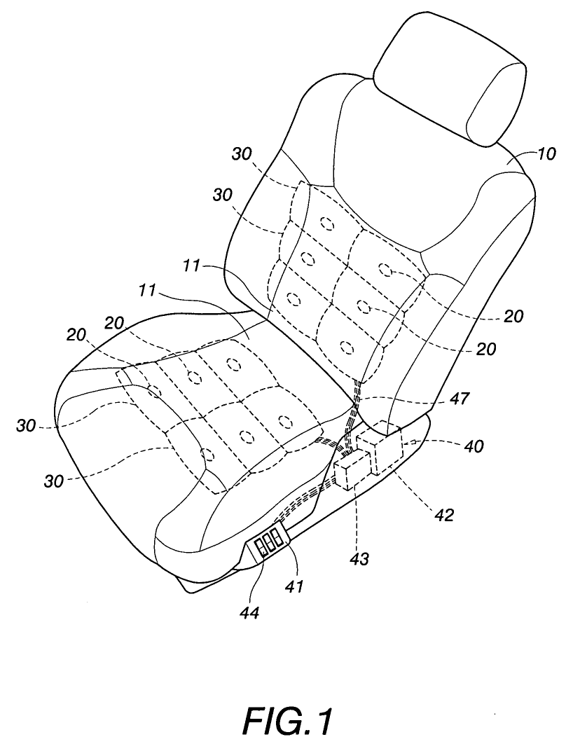

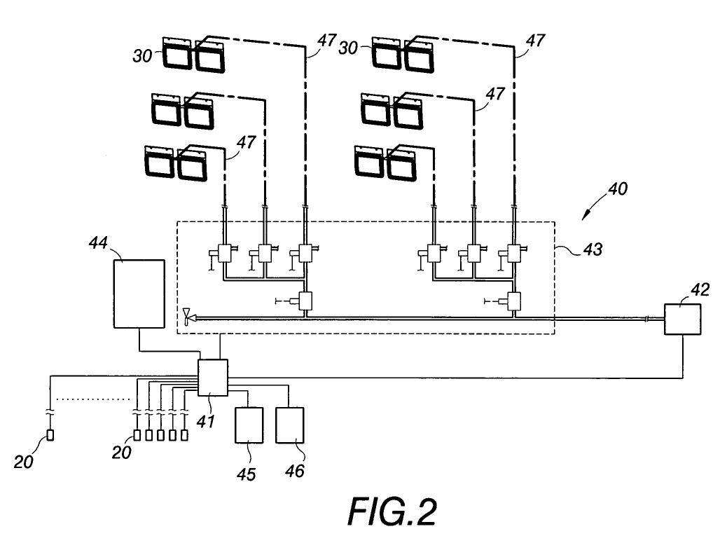

With reference to FIGS. 1 and 2 for schematic views of an installation position of a seat adjusting system and an assembly of each component in accordance with a first preferred embodiment of the present invention respectively, the seat adjusting system comprises a plurality of stress detectors 20 installed inside a seat 10 for detecting a stress distribution situation of a seat support surface 11, a plurality of airbags 30 buried into an internal side of the support surface 11, and an inflation/deflation control device 40. If stresses are exerted onto the airbags 30 on the internal side of the support surface 11 of the seat 10, then the stress detector 20 will detect the stresses exerted by the airbags 30, and a stress parameter will be released to the inflation/deflation control device 40, such that the inflation/deflation control device 40 will actively control the inflation/deflation ratio of each airbag 30 according to the stress parameter.

The inflation/deflation control device 40 comprises a control unit 41 connected to each stress detector 20 for obtaining the stress parameter, a pump 42 connected to the control unit 41, an air valve assembly 43 connected to the control unit 41, an operating interface 44 connected to the control unit 41, a built-in memory 45 connected to the control unit 41, a portable storage device 46 connected to the control unit 41, and a plurality of ventilation pipelines 47 connected to each airbag 30.

In a preferred embodiment, the operating interface 44 is provided for users to adjust the mode of the support surface 11 manually or automatically, and the electric power required for the whole system is supplied by a power supply device (not shown in the figure) such as an electric connector connected to an automobile power supply or an electric adapter for converting a high voltage current into a low voltage current, etc.

In addition to the aforementioned seat adjusting system, the present invention also provides a seat adjusting method, wherein each stress sensor 20 is used for detecting a stress distribution situation of the seat support surface 11, and the inflated/deflated mode of each airbag 30 is controlled by the inflation/deflation control device 40, and each stress sensor 20 is connected to the control unit 41 of the inflation/deflation control device 40 to produce a corresponding stress parameter, and the control unit 41 is connected to the built-in memory 45 for preloading an optimal stress parameter ratio.

If a user sits in a seat, the inflation/deflation control device 40 will inflate each airbag 30 to an appropriate level, and then use each stress sensor 20 to detect an actual stress distribution situation of the seat support surface 11 at that time, and transmit the obtained actual stress parameter ratio to the control unit 41 of the inflation/deflation control device 40. The control unit 41 compares the actual stress parameter ratio with a preloaded optimal stress parameter ratio. In the meantime, the inflation/deflation control device 40 also drives the pump 42 and the air valve assembly 43 to adjust the inflated/deflated mode of each airbag 30 according to a comparison result. When the inflation or deflation of each airbag 30 is adjusted, the aforementioned comparison procedure and adjusting procedure are performed in cycles, and the adjusting procedure is stopped until the actual stress parameter ratio is matched with the optimal stress parameter ratio, so that the users can obtain a larger contact area and a support effect without excessively concentrated stress.

For instance, if a user sits in a seat, the original stress distribution situation between the support surface 11 and the user is generally concentrated at a specific area of the user's buttocks and only a very small portion of the stresses is scattered to the middle and front sections of the user's thigh. With the seat adjusting method, the support surface 11 can have a change of three-dimensional level, such that the contact area between the support surface 11 and the user's buttocks and thigh is increased, and the original stress concentrated at the specific area of the user's buttocks can be scattered appropriately from the periphery of the original specific area to the middle and front sections of the user's thigh. By such stress detection adjusting measure, the present invention can actively provide users a more comfortable and objective support effect.

In practices, the aforementioned portable storage device 46 can upload data to the control unit 41 or download data from the control unit 41, such as uploading or downloading related stress parameters or control codes. The portable storage device 46 can be a universal serial bus (USB) memory stick or any other portable memory card or storage medium with a general specification, such as CF, Micro Drive, Smart Media, Memory Stick, Mage Gate, Multi Media CARD, Secure Digital, xD Picture Card, external hard disk drive (HDD), and IC memory device, etc.

The aforementioned portable storage device 46 can be connected to the control unit 41 through an electric port or a wireless transmission interface connected to the control unit 41, such as various types of communication ports, memory card sockets, Bluetooth transmission interfaces, infrared transmission interfaces, radio frequency transmission interfaces, etc, and users simply need to operate the operating interface 44 to control operations such as uploading, downloading or executing data with the portable storage device 46. The aforementioned electric port or wireless transmission interface is provided for connecting the control unit with the network system or other terminals.

The airbags 30 are installed symmetrically on the left and right sides on the seat 10, and each airbag 30 has an inflation/deflation control, and two adjacent airbags 30 are interconnected to form a synchronous inflating/deflating airbag set. In addition to the adjusting function, the inflation/deflation control device 40 also maintains the inflation/deflation of each airbag 30, provides a support function, and further provides a continuous or intermittent dynamic inflation/deflation control to specific airbags 30, so as to achieve a massaging effect.

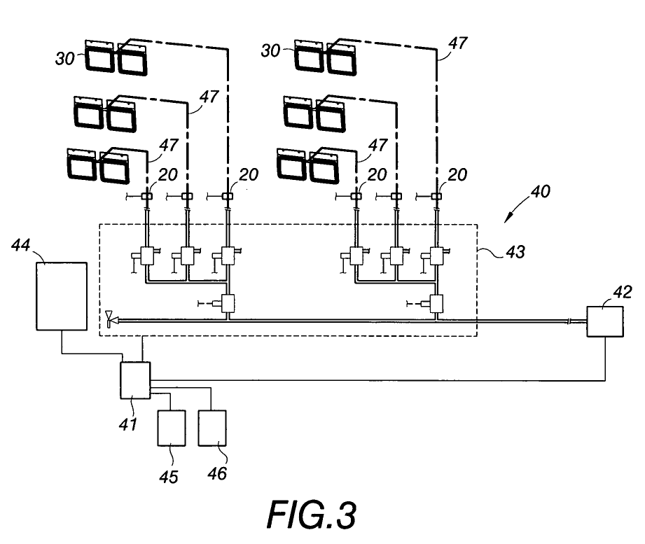

With reference to FIG. 3 for a schematic view of an assembly of a seat adjusting system in accordance with a second preferred embodiment of the present invention, the stress sensors 20 can be installed on the ventilation pipeline 47 in addition to the positions between each airbag 30 and the support surface 11 as shown in FIG. 1, so that the stress sensors 20 can still reflect the stress distribution situation of the support surface 11 by means of the fluid properties of the air.

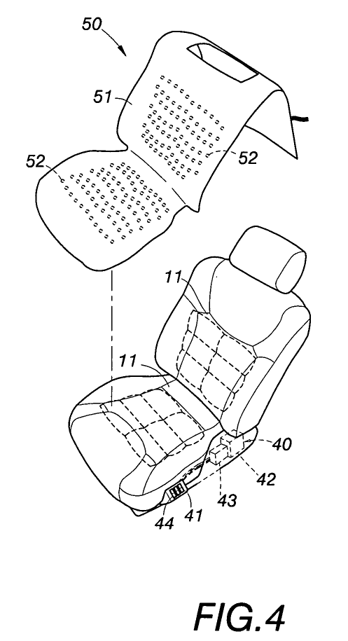

With reference to FIG. 4 for a schematic view of an assembly of a seat adjusting system in accordance with a third preferred embodiment of the present invention, the seat adjusting system further comprises an auxiliary medical detector 50, and the auxiliary medical detector 50 includes a cushion 51 laid on the seat 10 (covered onto the support surface 11), and a plurality of precision stress detectors 52 densely distributed on the cushion, such that the auxiliary medical detector 50 can use a display device to display data or graphics of the stress distribution situation and provide the data or graphics to medical professionals for a professional judgment and allow medical professionals to adjust the mode of each support surface 11 manually. The seat adjusting system of the present invention can be applied to the auxiliary medical applications.

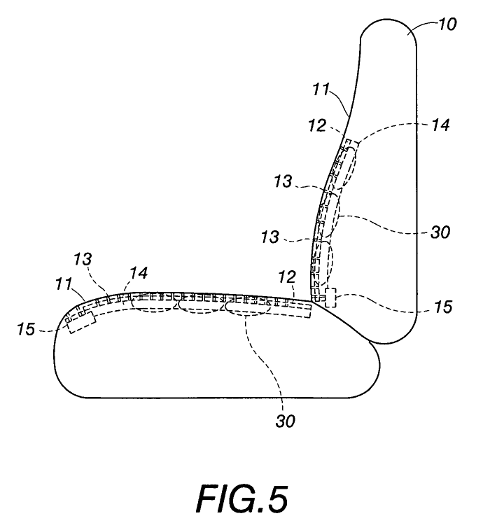

With reference to FIG. 5 for a schematic view of an assembly of a seat adjusting system in accordance with a fourth preferred embodiment of the present invention, the seat adjusting system includes an electrothermal component 12 such as an electrothermal silk or an electrothermal cloth installed on an internal side of the support surface 11, so that the seat adjusting system can provide a warmth retention effect. Alternately, the seat adjusting system includes a plurality of ventilation holes 13 disposed on the support surface 11 and an air passage 14 built in the seat 10 for circulating an air flow. The air passage 14 is connected to an air blower 15. When the air blower 15 produces an air flow, the air passage 14 and the ventilation holes 13 are provided for the ventilation of the support surface 11, such that the seat adjusting system can have a ventilation effect.

While the invention has been described by means of specific embodiments, numerous modifications and variations could be made thereto by those skilled in the art without departing from the scope and spirit of the invention set forth in the claims.

What is claimed is:

1. A seat adjusting method, comprising the steps of:
burying a plurality of airbags into an internal side of a support surface, wherein an inflated or deflated state of each airbag is controlled by an inflation/deflation control device;
detecting a stress distribution situation of a seat support surface by a plurality of stress sensors;
outputting a detected stress of each stress sensor to a control unit to produce a corresponding stress parameter, wherein the control unit is connected to a built-in memory for preloading an optimal stress parameter ratio;
using the control unit to compare an actual stress parameter ratio obtained by the stress sensor with an optimal stress parameter ratio, when a user sits in a seat; and
performing an adjusting procedure for inflating or deflating each airbag by the inflation/deflation control device according to a comparison result, wherein the comparison procedure and the adjusting procedure are carried out in cycle, and stopped until the actual stress parameter ratio is matched with the optimal stress parameter ratio.

2. The seat adjusting method of claim 1, wherein after the actual stress parameter ratio is matched with the optimal stress parameter ratio, a corresponding stress parameter of each stress sensor is recorded in the built-in memory, such that if the same user sits in the seat again, the control unit will not perform the comparison procedure, but will directly drive the inflation/deflation control device to perform the adjusting procedure for inflating/deflating the airbags, and will stop the adjusting procedure when the inflated/deflated mode of each airbag corresponds to the recorded stress parameter.

3. The seat adjusting method of claim 1, wherein the control unit is connected to a portable storage device, such that after the actual stress parameter ratio is matched with the optimal stress parameter ratio, the corresponding stress parameter of each stress sensor is recorded into the portable storage device and provided for a convenient carry for the user.

4. The seat adjusting method of claim 1, wherein the inflation/deflation control device further performs a continuous or intermittent dynamic inflation/deflation control to specific airbags.

5. A seat adjusting system, comprising:
a plurality of airbags, buried into an internal side of a seat support surface;
a plurality of stress detectors, for detecting a surface stress distribution situation of a seat support and outputting a stress parameter;
an inflation/deflation control device, connected to each stress detector for actively controlling an inflation or a deflation of each airbag according to the stress parameter, and the inflation/deflation control device comprising a control unit connected to each stress detector for obtaining the stress parameter, a pump connected to the control unit, an air valve assembly connected to the control unit, an operating interface connected to the control unit, a built-in memory connected to the control unit for preloading an optimal stress parameter ratio; and
a power supply device, for supplying electric power required for the operation of the seat adjusting system.

6. The seat adjusting system of claim 5, wherein the inflation/deflation control device further comprises a portable storage device connected to the control unit.

7. The seat adjusting system of claim 5, wherein the stress sensor is installed between each airbag and the support surface.

8. The seat adjusting system of claim 5, further comprising a ventilation pipeline between each airbag and the inflation/deflation control device, and the stress sensor is installed on the ventilation pipeline.

9. The seat adjusting system of claim 5, wherein the inflation/deflation control device includes an electric port connected to the control unit for performing a data transmission.

10. The seat adjusting system of claim 5, wherein the inflation/deflation control device includes a wireless transmission interface connected to the control unit and provided for a data transmission.

11. The seat adjusting system of claim 5, wherein the support surface has an electrothermal component installed at an internal side of the support surface.

12. The seat adjusting system of claim 5, wherein the support surface includes a plurality of ventilation holes disposed thereon, an air passage disposed inside the seat for circulating an air flow and connecting the air passage with an air blower, such that when the air blower produces an air flow, the air flow passes through the air passage and the ventilation holes on the support surface for achieving a ventilation effect.

13. The seat adjusting system of claim 5, further comprising an auxiliary medical detector, and the auxiliary medical detector includes a cushion laid on the seat and a plurality of precision stress detectors densely distributed on the cushion.
